(19) United States
(12) Patent Application Publication
(10) Pub. No.: US 2015/0058370 A1
(43) Pub. Date: Feb. 26, 2015

(54) Method and apparatus for validating multimedia data

(71) Applicant: P2S MEDIA GROUP OY, Helsinki (FI)

(72) Inventor: Timo Johannes Rinne, Helsinki (FI)

(21) Appl. No.: 14/367,931

(22) PCT Filed: Dec. 19, 2012
(86) PCT No.: PCT/FI2012/051271

§ 371 Date: Jun. 22, 2014

(30) Foreign Application Priority Data
Dec. 29, 2011 (FI) 20116332

(51) Int. Cl. G06F 17/30; H04L 29/08

(52) U.S. Cl. CPC G06F 17/30595; H04L 67/10
USPC 707/758

(57) ABSTRACT

An apparatus including: a communication interface for receiving a multimedia data item associating captured multimedia data with metadata; at least one processor; and at least one memory including computer program code; wherein the at least one memory and the computer program code configured to, with the at least one processor, cause the apparatus to: maintain reference metadata for a multimedia device (610); and receive the multimedia data item from the multimedia device (620). The apparatus is further caused to determine the associated metadata from the received multimedia data item (630); compare the associated metadata with the reference metadata to provide authenticity information (640); and validate the captured multimedia data based on the authenticity information (650).

### TECHNICAL FIELD

The present application generally relates to a method and an apparatus for providing enhanced authenticity for a multimedia data item. The present application further relates to a method and an apparatus for validating captured multimedia data based on authenticity information.

### BACKGROUND ART

A mobile apparatus may create multimedia data using, for example, camera and voice recording means for producing still images and/or streaming voice or video data. The mobile apparatus may also have some connectivity means for connecting the device to a network or to another device for uploading the captured images from the storage media of the camera to another storage media.

Services exist in networks, e.g. the Internet, for managing data, e.g. multimedia data, received from mobile apparatuses. The services are typically accessed via a web browser or using a client application made specifically for the purpose of accessing the service.

Mobile apparatuses are also connectable to devices such as cameras using a wired or wireless data communication means. The wired data communication means may be e.g. a USB (Universal Serial Bus) connection. The wireless data communication means may utilize be e.g. a Bluetooth or a Wireless LAN connection between the apparatus and the camera.

Because the service system provide multimedia data for users, the authenticity of the provided multimedia data is required. A solution for providing a validation of the captured multimedia data for a server apparatus receiving the multimedia data, is needed. Such validation should improve the authenticity of the multimedia captured by a certain multimedia device.

### SUMMARY

According to a first example aspect of the invention there is provided an apparatus comprising:
a communication interface for receiving a multimedia data item associating captured multimedia data with metadata;
at least one processor; and
at least one memory including computer program code;
   wherein the at least one memory and the computer program code configured to, with the at least one processor, cause the apparatus to:
maintain reference metadata for a multimedia device;
receive the multimedia data item from the multimedia device;
determine the associated metadata from the received multimedia data item;
compare the associated metadata with the reference metadata to provide authenticity information; and
validate the captured multimedia data based on the authenticity information.

In an embodiment, the apparatus may comprise a server apparatus.

In an embodiment, the reference metadata comprises at least one of the following elements:
a multimedia device identifier;
multimedia device model information;
software version information of the multimedia device;
resolution information of the multimedia device; and
parameters of a camera of the multimedia device.

In an embodiment, the associated metadata comprises at least one of the following elements:
a multimedia device identifier;
multimedia device model information;
software version information of the multimedia device;
resolution information of the multimedia device; and
parameters of a camera of the multimedia device.

In an embodiment, the associated metadata is stored to the reference metadata in response to the validating step.

in an embodiment, the reference metadata is received over the communication interface.

In an embodiment, the at least one memory and the computer program code configured to, with the at least one processor, cause the apparatus to:
maintain reference metadata for a multimedia device, wherein the reference metadata comprises a multimedia device identifier;
determine the multimedia device identifier from the associated metadata; and
retrieve the reference metadata based on the multimedia device identifier.

At least one element of the associated metadata may be compared with a corresponding element of the reference metadata.

Furthermore, at least two elements of the associated metadata may be compared with corresponding elements of the reference metadata, wherein the at least two elements of the associated metadata have different weight factors.

According to a second example aspect of the invention there is provided a method for providing enhanced authenticity for a multimedia data item, the multimedia data item associating captured multimedia data with metadata, wherein the method comprising:
maintaining reference metadata for a multimedia device;
receiving the multimedia data item from the multimedia device;
determining the associated metadata from the received multimedia data item;
comparing the associated metadata with the reference metadata to provide authenticity information; and
validating the captured multimedia data based on the authenticity information.

In an embodiment, the multimedia data is captured using at least one of the following:
proprietary multimedia capturing application of a user apparatus;
default multimedia capturing application of a user apparatus; and
multimedia capturing application of a multimedia device.

According to a third example aspect of the invention there is provided a computer program embodied on a computer readable medium comprising computer executable program code which, when executed by at least one processor of an apparatus, causes the apparatus to:
maintain reference metadata for a multimedia device;
receive the multimedia data item from the multimedia device;
determine the associated metadata from the received multimedia data item;
compare the associated metadata with the reference metadata to provide authenticity information; and
validate the captured multimedia data based on the authenticity information.

Different non-binding example aspects and embodiments of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

The invention will be described, by way of example only, with reference to the accompanying drawings, in which:

FIG. 1 shows a schematic picture of a system according to an example embodiment of the invention;

FIG. 2 presents an example block diagram of a user apparatus in which various embodiments of the invention may be applied;

FIG. 3 presents an example block diagram of a multimedia device in which various embodiments of the invention may be applied;

FIG. 4 presents an example block diagram of a server apparatus in which various embodiments of the invention may be applied;

FIG. 5 shows an overall block diagram of an example multimedia data item; and

FIG. 6 shows a flow diagram showing operations in accordance with an example embodiment of the invention.

### DETAILED DESCRIPTION

In the following description, like numbers denote like elements.

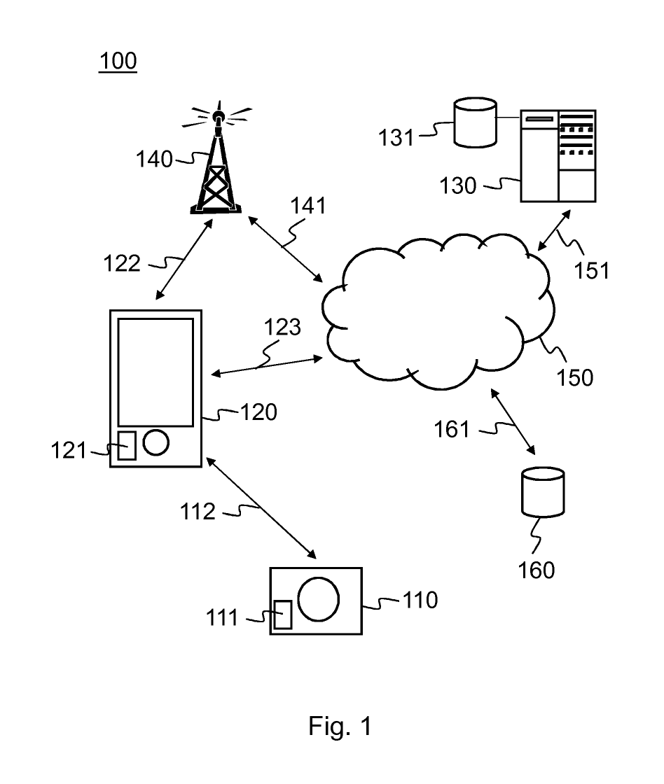

FIG. 1 shows a schematic picture of a system 100 according to an example embodiment of the invention. The system 100 comprises a multimedia device 110 configured to be capable of capturing multimedia, such as digital still images and/or video streams. The multimedia device 110 may comprise a storage 111 for multimedia data. The storage 111 may comprise a flash memory card, for example. The multimedia device 110 is configured to be connectable to a user apparatus 120 over a data connection 112. The data connection 112 may be a wired connection or a wireless connection. The wired connection may comprise Universal Serial Bus (USB), High-Definition Multimedia Interface (HDMI) or local area network (LAN), for example. The wireless connection may comprise Bluetooth™, Radio Frequency Identification (RF-ID) or wireless local area network (WLAN), for example.

The multimedia device 110 is configured to send captured multimedia data over the data connection 112 to the user apparatus 120. Such transmittal may be initiated by a user of the multimedia device 110, by a user of the user apparatus 120, or automatically based on settings. Such settings may comprise for example time of the day, amount of newly captured multimedia data or existence of the data connection 112 for the multimedia device 110.

The user apparatus 120 may comprise a multimedia device 110, a mobile phone, an internet tablet or a laptop computer, for example. The user apparatus 120 is capable of downloading and locally executing software program code. The software program code may be a client application of a service whose server application is running on the server apparatus 130 of the system 100. The user apparatus 120 may comprise multimedia capturing element, such as a camera, for capturing multimedia, such as still images or video streams, for example. The user apparatus 120 may also have a metadata element 121 for creating data usable as metadata of the multimedia content captured by the multimedia device 110. The metadata element 121 may comprise at least one of the following: a microphone, a positioning device for determining the current location of the user apparatus 120, and a clock. The user apparatus 120 is configured to be connectable to a wireless communication network 140 over a wireless connection 122. The wireless connection 122 may comprise a mobile cellular network or a wireless local area network (WLAN), for example. The wireless communication network may be to a public data communication network 150, for example the Internet, over a data connection 141.

In an embodiment, the system 100 comprises a server apparatus 130, which comprises a storage device 131 for storing multimedia and metadata received over a data connection 151. The system 100 may further comprise an external database 160, wherein multimedia and metadata may be stored over a data connection 161. The metadata stored in either of the storage device 131 or the external database 160 may comprise reference metadata, such as a multimedia device identifier, multimedia device model information, software version information of the multimedia device, resolution information of the multimedia device or parameters of a camera of the multimedia device, for example.

In an embodiment, multimedia data captured by a user may travel to a server apparatus 130 over different paths. A first path may comprise sending multimedia data captured by a proprietary application of a user apparatus 120 over a wireless communication network 122, 140, 141 and public data communication network 150, 151 to the server apparatus 130. A second path may comprise sending multimedia data captured by a default application of a user apparatus 120 over a wireless communication network 122, 140, 141 and public data communication network 150, 151 to the server apparatus 130. A third path may comprise sending multimedia data captured by a multimedia device 110 to the user apparatus 120 and therefrom over a wireless communication network 122, 140, 141 and public data communication network 150, 151 to the server apparatus 130. A fourth path may comprise sending multimedia data captured by the multimedia device 110 to a computer apparatus and therefrom over the public data communication network 150, 151 to the server apparatus 130.

In an embodiment, the proprietary application in the user apparatus 120 may be a client application of a service whose server application is running on the server apparatus 130 of the system 100. The proprietary application may capture the multimedia data for the first path. Also metadata for the captured multimedia may be retrieved by the proprietary application from the metadata elements 121 of the user apparatus 120. The default application may be an imaging application of the user apparatus 120. For the second path, the multimedia data captured by the default application may be imported to the proprietary application before transmitting to the server apparatus 130. The proprietary application may check the multimedia data and extract and apply metadata for the multimedia data. For the third path, the multimedia may be captured by the multimedia device 110 and transmitted to the proprietary application of the user apparatus 120 for sending to the server apparatus 130. The proprietary application may check the multimedia data and extract and apply metadata for the multimedia data. User may provide additional metadata using the user apparatus 120. For the fourth path, the multimedia may be captured by the multimedia device 110 and transmitted to a communication application of a computer apparatus. The communication application may check the multimedia data and extract and apply metadata for the multimedia data. User may provide additional metadata using the computer apparatus. In a further embodiment, the user may access the multimedia data on the server apparatus and provide additional metadata.

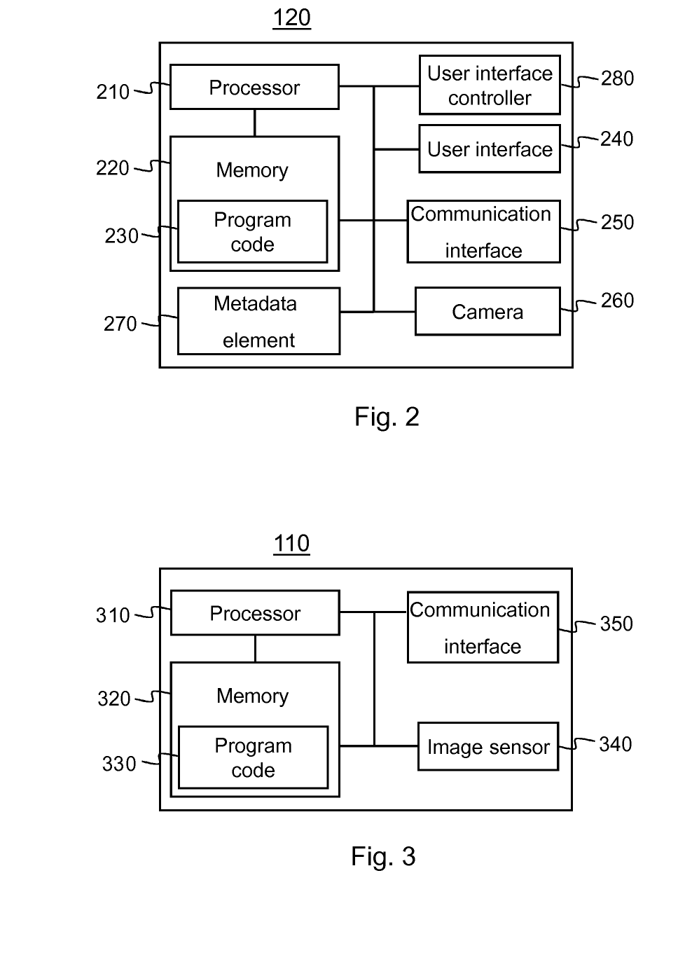

FIG. 2 presents an example block diagram of a user apparatus 120 in which various embodiments of the invention may be applied. The user apparatus 120 may be a multimedia device 110, a user equipment (UE), a user device or an apparatus, such as a mobile terminal, a smart phone or other communication device.

The general structure of the user apparatus 120 comprises a user interface 240, a communication interface 240, a metadata element 270, a camera, a processor 210, and a memory 220 coupled to the processor 210. The user apparatus 120 further comprises software 230 stored in the memory 220 and operable to be loaded into and executed in the processor 210. The software 230 may comprise one or more software modules and can be in the form of a computer program product. The software 230 may also provide metadata information relating to the software and hardware of the user apparatus 120. The user apparatus 210 may further comprise a user interface controller 280.

The processor 210 may be, e.g., a central processing unit (CPU), a microprocessor, a digital signal processor (DSP), a graphics processing unit, or the like. FIG. 2 shows one processor 210, but the user apparatus 120 may comprise a plurality of processors.

The memory 220 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The user apparatus 120 may comprise a plurality of memories. The memory 220 may be constructed as a part of the user apparatus 120 or it may be inserted into a slot, port, or the like of the user apparatus 120 by a user. The memory 220 may serve the sole purpose of storing data, or it may be constructed as a part of an apparatus serving other purposes, such as processing data. A proprietary multimedia application, a default multimedia application and multimedia data may be stored to the memory 220.

The user interface controller 280 may comprise circuitry for receiving input from a user of the user apparatus 120, e.g., via a keyboard, graphical user interface shown on the display of the user interfaces 240 of the user apparatus 120, speech recognition circuitry, or an accessory device, such as a headset, and for providing output to the user via, e.g., a graphical user interface or a loudspeaker.

The metadata element 270 comprises element configured to provide metadata information. Such elements may comprise, for example, a positioning device, an accelerometer, a temperature gauge, a clock or a microphone.

The camera 260 may be a still image camera or a video stream camera, capable for creating multimedia data and providing metadata information.

The communication interface module 250 implements at least part of radio transmission. The communication interface module 250 may comprise, e.g., a wireless or a wired interface module. The wireless interface may comprise such as a WLAN, Bluetooth, infrared (IR), radio frequency identification (RF ID), GSM/GPRS, CDMA, WCDMA, or LTE (Long Term Evolution) radio module. The wired interface may comprise such as universal serial bus (USB), for example. The communication interface module 250 may be integrated into the user apparatus 120, or into an adapter, card or the like that may be inserted into a suitable slot or port of the user apparatus 120. The communication interface module 250 may support one radio interface technology or a plurality of technologies. The user apparatus 12 may comprise a plurality of communication interface modules 250. Captured multimedia may be transmitted to a wireless communication network 140 using the communication interface 250.

A skilled person appreciates that in addition to the elements shown in FIG. 2, the user apparatus 120 may comprise other elements, such as microphones, extra displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the user apparatus 120 may comprise a disposable or rechargeable battery (not shown) for powering when external power if external power supply is not available.

In an embodiment, the user apparatus 120 comprises speech recognition means. Using these means, a pre-defined phrase may be recognized from the speech and translated into a metadata tag. This tag may then be used as any other metadata, for example for characterizing the captured multimedia or for grouping images together, for example.

FIG. 3 presents an example block diagram of a multimedia device 110 in which various embodiments of the invention may be applied. The multimedia device 110 may be a digital still camera or digital video camera, for example.

The general structure of the multimedia device 110 comprises a processor 310, and a memory 320 coupled to the processor 310. The multimedia device 110 further comprises software 330 stored in the memory 320 and operable to be loaded into and executed in the processor 310. The software 330 may comprise one or more software modules and can be in the form of a computer program product. The software 330 may provide metadata information of the software or hardware of the multimedia device 110.

The processor 310 may be, e.g., a central processing unit (CPU), a microprocessor, a digital signal processor (DSP), a graphics processing unit, or the like. FIG. 3 shows one processor 310, but the multimedia device 110 may comprise a plurality of processors.

The memory 320 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The multimedia device 110 may comprise a plurality of memories. The memory 320 may be constructed as a part of the multimedia device 110 or it may be inserted into a slot, port, or the like of the multimedia device 110 by a user. The memory 320 may serve the sole purpose of storing data, or it may be constructed as a part of an apparatus serving other purposes, such as processing data.

The image sensor 340 may be a device converting an optical image into an electronic signal, for example a charge-coupled device (CCD) or a complementary metal-oxide-semiconductor (CMOS) active pixel sensor. The image sensor 340 may provide metadata information of the image sensor 340.

The communication interface module 350 implements at least part of radio transmission. The communication interface module 350 may comprise, e.g., a wireless or a wired interface module. The wireless interface may comprise such as a WLAN, Bluetooth, infrared (IR), radio frequency identification (RF ID), GSM/GPRS, CDMA, WCDMA, or LTE (Long Term Evolution) radio module. The wired interface may comprise such as universal serial bus (USB), for example. The communication interface module 350 may be integrated into the multimedia device 110, or into an adapter, card or the like that may be inserted into a suitable slot or port of the multimedia device 110. The communication interface module 350 may support one radio interface technology or a plurality of technologies. The multimedia device 110 may comprise a plurality of communication interface modules 350. Captured multimedia data of the multimedia device 110 may be transmitted to a user apparatus 120 or to a computer apparatus using the communication interface 350.

A skilled person appreciates that in addition to the elements shown in FIG. 3, the multimedia device 110 may comprise other elements, such as microphones, displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the multimedia device 110 may comprise a disposable or rechargeable battery (not shown) for powering when external power if external power supply is not available

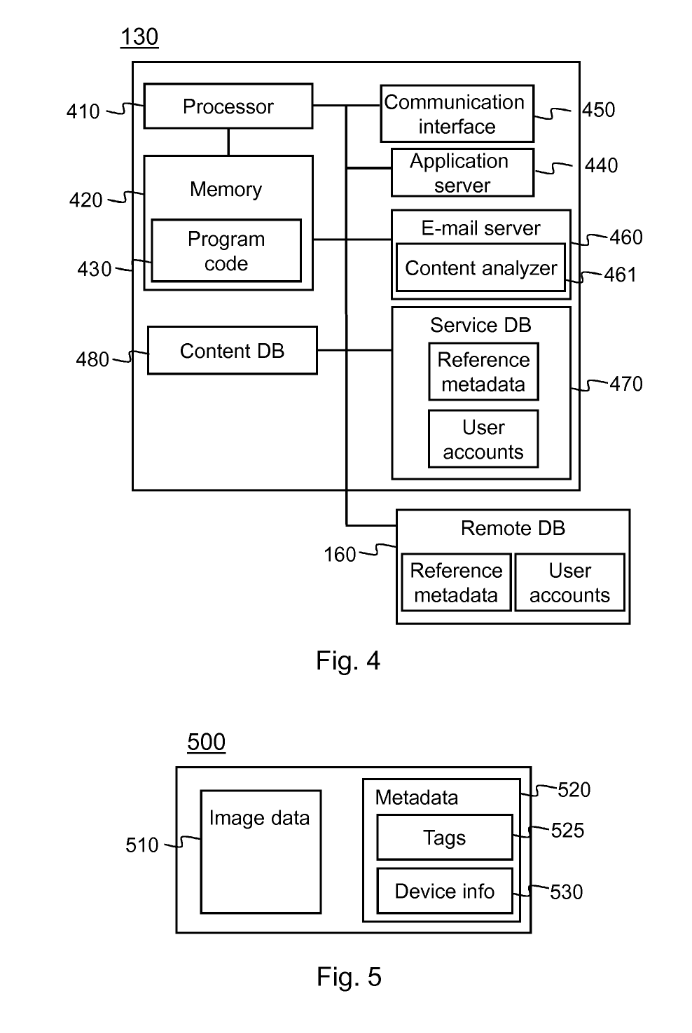

FIG. 4 presents an example block diagram of a server apparatus 130 in which various embodiments of the invention may be applied.

The general structure of the server apparatus 130 comprises a processor 410, and a memory 420 coupled to the processor 410. The server apparatus 130 further comprises software 430 stored in the memory 420 and operable to be loaded into and executed in the processor 410. The software 430 may comprise one or more software modules and can be in the form of a computer program product.

The processor 410 may be, e.g., a central processing unit (CPU), a microprocessor, a digital signal processor (DSP), a graphics processing unit, or the like. FIG. 4 shows one processor 410, but the server apparatus 130 may comprise a plurality of processors.

The memory 420 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The server apparatus 130 may comprise a plurality of memories. The memory 420 may be constructed as a part of the server apparatus 130 or it may be inserted into a slot, port, or the like of the server apparatus 130 by a user. The memory 420 may serve the sole purpose of storing data, or it may be constructed as a part of an apparatus serving other purposes, such as processing data.

The communication interface module 450 implements at least part of radio transmission. The communication interface module 450 may comprise, e.g., a wireless or a wired interface module. The wireless interface may comprise such as a WLAN, Bluetooth, infrared (IR), radio frequency identification (RF ID), GSM/GPRS, CDMA, WCDMA, or LTE (Long Term Evolution) radio module. The wired interface may comprise such as universal serial bus (USB), for example. The communication interface module 450 may be integrated into the server apparatus 130, or into an adapter, card or the like that may be inserted into a suitable slot or port of the server apparatus 130. The communication interface module 450 may support one radio interface technology or a plurality of technologies. The server apparatus 130 may comprise a plurality of communication interface modules 450. Captured multimedia data of the multimedia device 110 or the user apparatus 120 may be received by the server apparatus 130 using the communication interface 450.

The e-mail server process 460, which receives e-mail messages sent from user apparatuses 120 and computer apparatuses via the network 150. The server 460 may comprise a content analyzer module 461, which checks if the content of the received message meets the criteria that are set for new content data of the service. The content analyzer module 461 may for example check, whether the e-mail message contains a valid still image or a video stream. The valid content data received by the e-mail server is then sent to an application server 440, which provides application services e.g. relating to the user accounts stored in a user service database 470 and content of the content management service. In the service database 470 reference metadata for multimedia data validation may be stored. The reference metadata may also be stored in the external database 160, wherein multimedia and metadata may be stored over a data connection 161.

The metadata stored in either of the storage device 131 or the external database 160 may comprise reference metadata, such as a multimedia device identifier, multimedia device model information, software version information of the multimedia device, resolution information of the multimedia device or parameters of a camera of the multimedia device, for example. Furthermore, user account information may be stored in the service database 470 or in the external database 160. The user account information may comprise information of registered users and their registered apparatuses. Registration information may comprise for example, a multimedia device type, multimedia device model information or software version information of the multimedia device, for example. Content provided by the service system 100 is stored in a content database 480.

A skilled person appreciates that in addition to the elements shown in FIG. 4, the server apparatus 130 may comprise other elements, such as microphones, displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like.

FIG. 5 shows an overall block diagram of an example multimedia data item 500 according to an example embodiment of the invention.

The multimedia data item 500 comprises multimedia data 510, such as image data. Furthermore, the multimedia data item 500 comprises metadata 520. In an embodiment, the metadata 520 comprises multimedia device information 530 as a searchable metadata element for validation of the multimedia data item 500. The metadata 520 may further comprise metadata tags 525 for validation of the multimedia data item 500.

The metadata 520 may be written into the multimedia data item 500 for identifying who owns the multimedia data, such as image data 510, copyright & contact information, what camera created the file, along with exposure information and descriptive information such as keywords about the photo, making the file searchable on the computer and/or the Internet. Some metadata 520 may be written by the camera and further metadata 520 may be input by the photographer, user and/or computer software after downloading the multimedia data 510 to a computer, for example.

The metadata 520 may be configured to use a certain standard format, such as Exchangeable Image Format (EXIF). Specifically, FIG. 5 illustrates a single digital image 500 stored in the EXIF format, such as in a file on a computer or on a removable media device in a digital camera. As will be appreciated by those skilled in the art, an EXIF file 500 may contain multiple digital images having a similar format. The metadata 520 may also comprise at least two metadata, for example simple metadata and complex metadata. In FIG. 5 only a single metadata 520 is showed, for simplicity. The metadata 520 may include tags 525. The tags 525 include information such as descriptions, copyright information, date and time information, camera settings such as camera model and make, and information that varies with each image such as orientation (rotation), aperture, shutter speed, focal length, metering mode, location information, and ISO speed information. The tags may further comprise a thumbnail for previewing the picture on the camera's LCD screen, in file managers, or in photo manipulation software.

The metadata 520 format may comprise standard tags 525 for location information. Cameras and mobile devices may have a built-in GPS receiver or a cellular positioning device that stores the location information in the metadata tags 525 when the picture is taken. Some other cameras have a separate GPS receiver that fits into the flash connector, for example. Recorded GPS data can also be added to any digital photograph on a computer, either by correlating the time stamps of the photographs with a GPS record from a hand-held GPS receiver or manually using a map or mapping software. The process of adding geographic information to a photograph is known as geocoding. A system server may allow their users to upload geocoded pictures or to add geolocation information online.

In an embodiment, geographic location data is comprised in the tags 525. Furthermore, the device info 530 may be comprised in the tags 525.

In an embodiment, the metadata 520 may be configured to use any other standard format, such as:
IPTC Information Interchange Model IIM (International Press Telecommunications Council),
IPTC Core Schema for XMP,
XMP—Extensible Metadata Platform (an Adobe standard),
Dublin Core (Dublin Core Metadata Initiative—DCMI), or
PLUS (Picture Licensing Universal System).

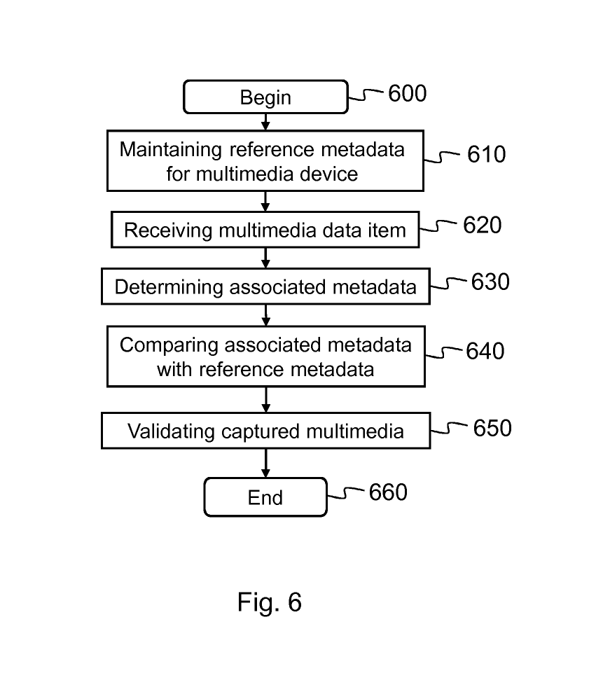

FIG. 6 shows a flow diagram showing operations in accordance with an example embodiment of the invention. In step 600, the method for providing enhanced authenticity for a multimedia data item, the multimedia data item associating captured multimedia data with metadata, is started. In step 610, reference metadata for a multimedia device is maintained. In step 620, the multimedia data item is received from the multimedia device. The associated metadata is determined from the received multimedia data item in step 630. In step 640, the associated metadata is compared with the reference metadata to provide authenticity information. The captured multimedia data is validated based on the authenticity information in step 650. The method ends in step 660.

Various embodiments have been presented. It should be appreciated that in this document, words comprise, include and contain are each used as open-ended expressions with no intended exclusivity. If desired, the different functions discussed herein may be performed in a different order and/or concurrently with each other. Furthermore, if desired, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1. A server apparatus comprising:
a communication interface for receiving a multimedia data item associating captured multimedia data with metadata;
at least one processor; and
at least one memory including computer program code;
the at least one memory and the computer program code configured to, with the at least one processor, cause the server apparatus to:
maintain reference metadata for a multimedia device at the server apparatus, wherein the reference metadata comprising at least one of the following: multimedia device model information, software version information of the multimedia device, resolution information of the multimedia device and parameters of a camera of the multimedia device;
receive the multimedia data item from the multimedia device;
determine the associated metadata from the received multimedia data item;
compare the associated metadata, by the server apparatus, with the reference metadata to provide authenticity information; and
validate the captured multimedia data based on the authenticity information.

2. The server apparatus of claim 1, wherein the reference metadata further comprises:
a multimedia device identifier.

3. The server apparatus of claim 1, wherein the associated metadata comprises at least one of the following elements:
a multimedia device identifier;
multimedia device model information;
software version information of the multimedia device;
resolution information of the multimedia device; and
parameters of a camera of the multimedia device.

4. The server apparatus of claim 1, wherein the at least one memory and the computer program code further configured to, with the at least one processor, cause the apparatus to:
store the associated metadata to the reference metadata in response to the validating step.

5. The server apparatus of claim 1, wherein the at least one memory and the computer program code further configured to, with the at least one processor, cause the apparatus to:
receive the reference metadata over the communication interface.

6. The server apparatus of claim 1, wherein the at least one memory and the computer program code further configured to, with the at least one processor, cause the apparatus to:
maintain reference metadata for a multimedia device, wherein the reference metadata comprises a multimedia device identifier;
determine the multimedia device identifier from the associated metadata; and
retrieve the reference metadata based on the multimedia device identifier.

7. The server apparatus of claim 6, wherein the at least one memory and the computer program code further configured to, with the at least one processor, cause the apparatus to:
compare at least one element of the associated metadata with a corresponding element of the reference metadata.

8. The server apparatus of claim 6, wherein the at least one memory and the computer program code further configured to, with the at least one processor, cause the apparatus to:
compare at least two elements of the associated metadata with corresponding elements of the reference metadata, wherein the at least two elements of the associated metadata have different weight factors.

9. (canceled)

10. A method for providing enhanced authenticity for a multimedia data item, the multimedia data item associating captured multimedia data with metadata, the method comprising:
maintaining reference metadata at a server apparatus for a multimedia device, wherein the reference metadata comprising at least one of the following: multimedia device model information, software version information of the multimedia device, resolution information of the multimedia device and parameters of a camera of the multimedia device;
receiving the multimedia data item, at the server apparatus, from the multimedia device;
determining the associated metadata from the received multimedia data item;
comparing the associated metadata with the reference metadata, by the server apparatus, to provide authenticity information; and
validating the captured multimedia data based on the authenticity information.

11. A computer program embodied on a non-transitory computer readable medium comprising computer executable program code which, when executed by at least one processor of a server apparatus, causes the server apparatus to:
maintain reference metadata at a server apparatus for a multimedia device, wherein the reference metadata comprising at least one of the following: multimedia device model information, software version information of the multimedia device, resolution information of the multimedia device and parameters of a camera of the multimedia device;
receive the multimedia data item from the multimedia device;
determine the associated metadata from the received multimedia data item;
compare the associated metadata with the reference metadata, by the server apparatus, to provide authenticity information; and
validate the captured multimedia data based on the authenticity information.

12. The method of claim 10, further comprising:
receiving the multimedia data item, at the server apparatus, from the multimedia device over a first path comprising sending multimedia data captured by a proprietary application of a user apparatus over a wireless communication network and public data communication network to the server apparatus.

13. The method of claim 10, further comprising:
receiving the multimedia data item, at the server apparatus, from the multimedia device over a second path comprising sending multimedia data captured by a default application of a user apparatus over a wireless communication network and public data communication network to the server apparatus.

14. The method of claim 10, further comprising:
receiving the multimedia data item, at the server apparatus, from the multimedia device over a third path comprising sending multimedia data captured by a multimedia device to a user apparatus and therefrom over a wireless communication network and public data communication network to the server apparatus.

15. The method of claim 10, further comprising:
receiving the multimedia data item, at the server apparatus, from the multimedia device over a fourth path comprising sending multimedia data captured by the multimedia device to a computer apparatus and therefrom over the public data communication network to the server apparatus.

16. The method of claim 15, further comprising:
transmitting the multimedia data captured by the multimedia device to a communication application of the computer apparatus;
checking the multimedia data by the communication application; and
extracting and applying metadata for the multimedia data.

17. The method of claim 16, further comprising:
providing, by a user, additional metadata using the computer apparatus.

18. The method of claim 16, further comprising:
accessing, by a user, the multimedia data on the server apparatus and provide additional metadata.

19. The method of claim 10, further comprising:
capturing the multimedia data using a proprietary multimedia capturing application of a user apparatus, wherein the proprietary multimedia capturing application being a client application of a service whose server application is running on the server apparatus.

20. The method of claim 10, further comprising:
capturing the multimedia data using a default multimedia capturing application of a user apparatus.

21. The method of claim 10, further comprising:
capturing the multimedia data using a multimedia capturing application of the multimedia device.
